(19) United States
(12) Patent Application Publication
(10) Pub. No.: US 2017/0053311 A1
(43) Pub. Date: Feb. 23, 2017

(54) METHOD AND SYSTEM FOR DISPLAYING AN ADVERTISEMENT ON A PAYMENT CARD

(71) Applicant: MasterCard International Incorporated, Purchase, NY (US)

(72) Inventors: Avyaktanand Tiwary, Gurgaon (IN); Shikha Goel Mittal, Haryana (IN); Vikhyat Shukla, Gurgaon (IN)

(21) Appl. No.: 15/240,373

(22) Filed: Aug. 18, 2016

(30) Foreign Application Priority Data
Aug. 18, 2015 (SG) 10201506485T

(51) Int. Cl. G06Q 30/02; G06K 19/077

(52) U.S. Cl. CPC G06Q 30/0255; G06K 19/077

(57) ABSTRACT

Method and system for displaying an advertisement on a payment card. The method may be executed using a computer coupled to a database and the payment card may comprise a display screen. The method includes: retrieving, using the computer, an advertisement stored on the database; and transmitting the advertisement from the computer to the payment card for displaying the advertisement on the display screen, wherein at least one pre-defined rule is applied to determine the retrieval of the advertisement from the database and/or transmittal of the advertisement to the payment card.

### CROSS-REFERENCE TO RELATED APPLICATION

This application is a U.S. National Stage filing under 35 U.S.C. §119, based on and claiming benefit of and priority to SG Patent Application No. 10201506485T filed Aug. 18, 2015.

### FIELD OF INVENTION

The present invention relates broadly, but not exclusively, to methods and systems for displaying an advertisement on a payment card.

### BACKGROUND

A merchant typically engages in advertising activities to call a potential customer's attention to products offered by the merchant in the hope that the potential customer purchases the merchant's products. Traditional media used for advertisements include billboards, printed flyers, newspapers, radio, television, Internet webpage banners/popups, and public transport (e.g. sides of buses, subway platforms and trains).

In most cases where traditional media is used, the advertisements are not targeted in the sense that the advertisements are directed at the general public, without specifically being directed to consumers that are more likely to be receptive to the advertisements. Non-targeted advertisements are usually less effective than targeted advertisements since not all advertisements may appeal to the general public.

Some forms of advertisements may be directed at a captive audience. For example, movie-goers at a cinema can be considered a captive audience when advertisements are shown to them before the movie starts and it is hard for the audience to ignore the advertisements. In contrast, advertisements shown on billboards placed on the street can be easily ignored by people passing by the billboards. Advertisements that are directed at a non-captive audience are usually less effective since such advertisements may be easily ignored.

A need therefore exists to provide methods and systems for displaying an advertisement on a payment card that seek to address at least the above-mentioned problems.

### SUMMARY

According to a first aspect of the present invention, there is provided a method for displaying an advertisement on a payment card using a computer coupled to a database, the payment card comprising a display screen, the method comprising: retrieving, using the computer, an advertisement stored on the database; and transmitting the advertisement from the computer to the payment card for displaying the advertisement on the display screen, wherein at least one pre-defined rule is applied to determine the retrieval of the advertisement from the database and/or transmittal of the advertisement to the payment card.

In an embodiment, the method may further comprise: receiving, at the computer, payment card identification data associated with the payment card for identifying a payment card holder; and obtaining, using the computer, historical behavioral data of the payment card holder, wherein the pre-defined rule comprises retrieval of the advertisement based on the obtained historical behavioral data of the payment card holder. The historical behavioral data of the payment card holder may comprise historical spend behavior derived from transaction data corresponding to transactions made using the payment card.

In an embodiment, the method may further comprise assigning, using the computer, a ranking to the advertisement based on a price paid for displaying the advertisement on the display screen, wherein the pre-defined rule comprises retrieval of the advertisement based on its ranking.

In an embodiment, the method may further comprise assigning, using the computer, a tag to the advertisement based on an advertiser's targeting strategy, wherein the pre-defined rule comprises retrieval of the advertisement based on the advertiser's targeting strategy.

In an embodiment, the payment card identification data may be received from a point-of-sale terminal during authorization of a transaction. The payment card identification data may comprise at least one of an account number, a unique identifier and cardholder identification data.

In an embodiment, the advertisement may comprise data corresponding to a message for calling a consumer's attention to a product.

In an embodiment, the method may further comprise: retrieving, using the computer, a loyalty program message stored on the database; and transmitting the loyalty program message from the computer to the payment card for displaying the loyalty program message on the display screen, wherein the at least one pre-defined rule is applied to determine the retrieval of the loyalty program message from the database and/or transmittal of the loyalty program message to the payment card.

According to a second aspect of the present invention, there is provided a network-based system for displaying an advertisement on a payment card, the system comprising: a payment card interface module communicatively coupleable to the payment card; and a computer communicatively coupled to the payment card interface module and configured to: retrieve the advertisement that is stored on a database; transmit the retrieved advertisement to the payment card interface module; and apply at least one pre-defined rule to determine the retrieval of the advertisement from the database and/or transmittal of the advertisement to the payment card interface module, wherein the payment card interface module is configured to: receive the advertisement from the computer and transmit the advertisement to the payment card when communicatively coupled to the payment card, wherein the payment card comprises a display screen that is configured to display the advertisement.

In an embodiment, the computer may be further configured to: receive payment card identification data associated with the payment card for identifying a payment card holder; and obtain historical behavioral data of the payment card holder, wherein the pre-defined rule comprises retrieval of the advertisement based on the obtained historical behavioral data of the payment card holder. The historical behavioral data of the payment card holder may comprise historical spend behavior derived from transaction data corresponding to transactions using the payment card.

In an embodiment, the payment card interface module may comprise a point-of-sale terminal that is configured to receive the payment card identification data during authorization of a transaction.

In an embodiment, the computer may be further configured to assign a ranking to the advertisement based on a price paid for displaying the advertisement on the display screen, wherein the pre-defined rule comprises retrieval of the advertisement based on its ranking.

In an embodiment, the computer may be further configured to assign a tag to the advertisement based on an advertiser's targeting strategy, wherein the pre-defined rule comprises retrieval of the advertisement based on the advertiser's targeting strategy.

In an embodiment, the computer may be further configured to: retrieve a loyalty program message stored on the database; transmit the retrieved loyalty program message to the payment card interface module; and apply the at least one pre-defined rule to determine the retrieval of the loyalty program message from the database and/or transmittal of the loyalty program message to the payment card interface module.

According to a third aspect of the present invention, there is provided payment card for use in an electronic payment transaction, the payment card comprising: a display screen; a processing device coupled to the display screen; and a communication module coupled to the processing device, the communication module configured to receive an advertisement from a computer communicatively coupled thereto, the computer configured to: retrieve the advertisement that is stored on a database; transmit the retrieved advertisement to the communication module; and apply at least one pre-defined rule to determine the retrieval of the advertisement from the database and/or transmittal of the advertisement to the communication module, wherein the processing device is configured to output the advertisement to the display screen for displaying the advertisement on the display screen.

In an embodiment, the communication module may be communicatively coupled to the computer via a point-of-sale terminal.

In an embodiment, the display screen may comprise a liquid-crystal display (LCD).

In an embodiment, the payment card may further comprise an energy storage device configured to provide operating power to the processing device, communication module and/or the display screen.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a flow chart illustrating a method for displaying an advertisement on a payment card according to an example embodiment;

FIG. 2 shows a schematic of a network-based system for displaying an advertisement on a payment card according to an embodiment of the invention;

FIG. 3 shows a schematic of a payment card for use in an electronic payment transaction according to an embodiment of the invention; and

FIG. 4 shows an exemplary computing device suitable for executing the method for displaying an advertisement on a payment card.

### DETAILED DESCRIPTION

Embodiments of the present invention will be described, by way of example only, with reference to the drawings. Like reference numerals and characters in the drawings refer to like elements or equivalents.

Currently, many merchants accept electronic payment transactions as an alternative to cash for the payment for products. In such electronic payment transactions, a payment card may be used. Typically, in a “card-present” electronic payment transaction, when a payment card holder (consumer) wishes to purchase a product from a merchant, the payment card holder presents his/her payment card to the merchant. The merchant typically has a point-of-sale (POS) terminal with a card reader that can interact/communicate with the payment card and facilitates the conduct of the electronic payment transaction. Examples of payment cards include, but are not limited to, credit cards, debit cards, charge cards, store-value cards, gift cards, and pre-paid cards. Payment cards are typically uniquely tied to a consumer or card holder account. As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transaction card can be used as a method of payment for performing a transaction.

The merchant typically submits a request to an acquirer (a financial institution that processes and settles the merchant's transactions with the help of an issuer). The acquirer then sends the request to the issuer (a financial institution, bank, credit union or company that issues or helps issue cards to payment card holders) to authorize the transaction. A financial institution/payment facilitator (e.g. MasterCard®) acts as an intermediary between the acquirer and the issuer. If the acquirer authorizes the transaction (e.g. there are sufficient funds/credit in the payment card holder's account), the merchant releases the product to the payment card holder.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

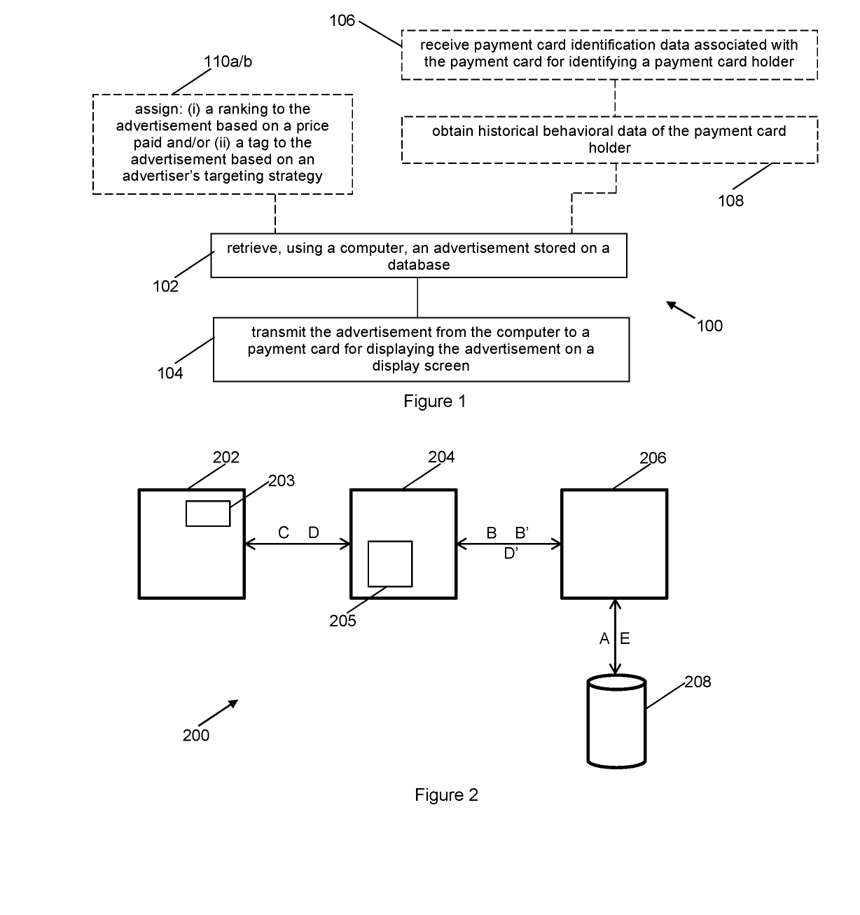

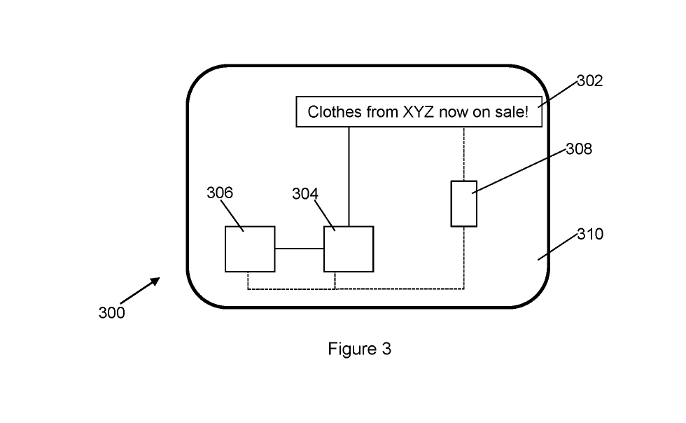

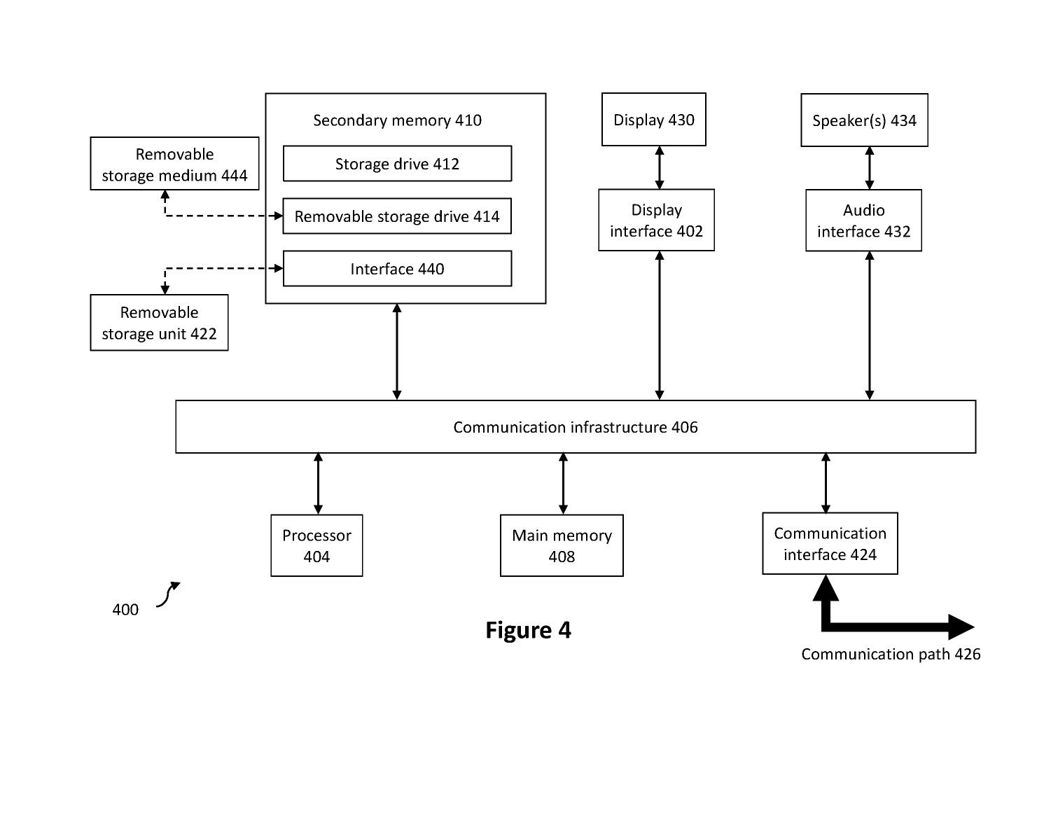

FIG. 1 shows a flow chart illustrating a method 100 for displaying an advertisement on a payment card according to an example embodiment. The method 100 may be performed by a computer that is coupled to a database. The payment card comprises a display screen. Further details on the computer and payment card will be provided below with reference to FIGS. 4 and 3, respectively. In the following description, an “advertisement” comprises data corresponding to a message for calling a consumer's attention to a product. A manufacturer of the product or merchant selling the product usually pays for the advertisement to be displayed.

The method 100 comprises a first step 102 of using the computer to retrieve one or more advertisements that are stored on/in the database. Thereafter, a second step 104 involves transmitting the advertisement from the computer to the payment card for displaying the advertisement on the display screen of the payment card. At least one pre-defined rule is applied to determine the retrieval of the advertisement from the database (at step 102) and/or transmittal of the advertisement to the payment card (at step 104) so that the advertisement can be displayed in a targeted manner, i.e. selectively. This advantageously improves the reach/effectiveness of the advertisement. In this context, “pre-defined” means that the rule is set prior to execution of the method 100, rather than being set in “real-time” during execution of the method 100.

A plurality of advertisements are stored on the database. Each advertisement may comprise at least one of: (i) a marketing message, i.e. data corresponding to a message for calling a consumer's attention to a product, (ii) a manufacturer or merchant who owns/is paying for the advertisement (i.e. an advertiser), (iii) a ranking of the advertisement, and (iv) a tag associated with the advertisement. More details on the ranking and tags will be provided below. The database can be accessed by the computer and one or more advertisements can be retrieved as per the first step 102. The retrieval of advertisements from the database is governed by the one or more pre-defined rules.

In some embodiments, the method 100 may comprise additional steps such as steps 106, 108 and 110a/b as described below. Steps 106, 108 and 110a/b are preferably, but not necessarily, executed prior to step 102.

In one implementation, the method 100 may further comprise the steps of: (i) receiving, at the computer, payment card identification data associated with the payment card for identifying a payment card holder (step 106); and then (ii) using the computer to obtain historical behavioral data of the payment card holder (step 108). In this implementation, the pre-defined rule comprises retrieval of the advertisement based on the obtained historical behavioral data of the payment card holder. That is, the historical behavioral data of the payment card holder determines whether or not a particular advertisement is retrieved from the database. Additionally or alternatively, the pre-defined rule may comprise transmittal of the advertisement to the payment card based on the obtained historical behavioral data of the payment card holder. In such a case, the historical behavioral data of the payment card holder determines whether or not a particular advertisement is transmitted to the payment card. In either case, the advertisement is displayed on the payment card in a targeted manner. This advantageously improves the reach/effectiveness of the advertisement.

The payment card identification data may comprise at least one of an account number, a unique identifier and card holder identification data. The payment card identification data is used to uniquely identify the payment card, and consequently the holder of the payment card. The payment card identification data may be received from a point-of-sale terminal (that is communicatively coupled with the computer) during authorization of a transaction.

In one implementation, the historical behavioral data of the payment card holder comprises historical spend behavior of the payment card holder. The historical spend behaviour can be derived from transaction data corresponding to transactions made using the payment card.

During a typical electronic payment transaction, certain data associated with the transaction (i.e. transaction data) may be generated and the transaction data may be captured/collected by the payment facilitator. For example, the transaction data may be uploaded to a data warehouse on a regular basis (e.g. daily, weekly, monthly). If necessary, various algorithms/rules can be applied to anonymize the transaction data so that no personally identifiable numbers are available to the users of the transaction data.

The following types of transaction data can be may be generated/captured:

### Transaction Level Information:

Transaction ID

Account ID (anonymized)

Merchant ID

Transaction Amount

Transaction Local Currency Amount

Date of Transaction

Time of Transaction

Type of Transaction

Date of Processing

Cardholder Present Code

Merchant Category Code (MCC)

### Account Information:

Account ID (anonymized)

Card Group Code

Card Product Code

Card Product Description

Card Issuer Country

Card Issuer ID

Card Issuer Name

Aggregate Card Issuer ID

Aggregate Card Issuer Name

### Merchant Information:

Merchant ID

Merchant Name

MCC/Industry Code

Industry Description

Merchant Country

Merchant Address

Merchant Postal Code

Aggregate Merchant ID

Aggregate Merchant Name

Merchant Acquirer Country

Merchant Acquirer ID

### Issuer Information:

Issuer ID

Issuer Name

Aggregate Issuer ID

Issuer Country

Using existing techniques known in the art, historical spend behavior of each payment card holder can be derived/determined from the transaction data corresponding to transactions made using the payment card. The derived historical spend behaviour of each payment card holder can then be stored in a database. The database can be the same database as the one containing the advertisements or can be a different database. In an implementation, the historical spend behavior provides an indication of the past purchasing pattern of the payment card holder, and this pattern can be used to determine which advertisement is displayed on the card holder's payment card. For example, if a customer has not purchased any products from a particular merchant (e.g. Walmart™) for the past three months, but has purchased products from another merchant having a similar MCC/industry type (e.g. Target™), advertisements for the particular merchant (i.e. Walmart™) can be displayed on the customer's payment card. In another example, assume that it has been found that customers that purchase products from one particular merchant (e.g. Macy's™) are likely to purchase products from another merchant in a different industry (e.g. Starbucks™). Accordingly, customers that have recently purchased products from Macy's™, but not from Starbucks™, may receive advertisements for Starbucks™ on their payment card. The historical spend behaviour of each payment card holder can be stored in a manner which is linked to the card holder's payment card identification data. By linking the historical spend behaviour of each payment card holder to his/her unique identifier, the relevant historical behavioral data can be obtained by the computer once the unique identifier is received.

In one implementation, the method 100 may further comprise the step of using the computer to assign a ranking to the advertisement based on a price paid for displaying the advertisement on the display screen (step 110a). In this implementation, the pre-defined rule comprises retrieval of the advertisement based on its ranking. A manufacturer of the product or merchant selling the product usually pays for the advertisement to be displayed. For example, if the manufacturer or merchant pays more for its advertisement(s) to be displayed, its advertisement(s) can be assigned a higher rank. Advertisements with a higher rank are retrieved more frequently from the database than advertisements with a relatively lower rank. Advertisements with a higher rank may also be transmitted more frequently to the payment card for display compared to advertisement with a relatively lower rank. Consequently, advertisements with a higher rank are displayed on payment cards more frequently than advertisements with a relatively lower rank.

In another implementation, the method 100 may further comprise the step of using the computer to assign a tag to the advertisement based on an advertiser's targeting strategy (step 110b). In this implementation, the pre-defined rule comprises retrieval of the advertisement based on the advertiser's targeting strategy. The advertiser's targeting strategy may be based on a characteristic of a potential consumer/customer of the manufacturer or merchant. Examples of such characteristics of the consumer include, but are not limited to: demographics (e.g. education, nationality, religion, ethnicity, income, age and gender) and location (city, state, country). More than one tag can be assigned to an advertisement. The tag may be a label or metadata that is used to locate (and retrieve) advertisements based on the advertiser's targeting strategy. For example, a tag may specify an age group that is most likely to be attracted to its corresponding advertisement. Thus, if an advertiser wishes to target consumers in a particular age group, e.g. 20-29 years old, advertisements with tags specifying an age group of “20-29” can be retrieved. Advertisements with tags specifying a different age group are not retrieved. In another example, a tag may specify a country with residents that are most likely to be attracted to its corresponding advertisement. Thus, if an advertiser wishes to target consumers in a particular country, e.g. Germany, advertisements with tags specifying “Germany” can be retrieved. Advertisements with tags specifying a different country are not retrieved.

FIG. 2 shows a schematic of a network-based system 200 for displaying an advertisement on a payment card 202 according to an embodiment of the invention. The system 200 comprises a payment card interface module 204 and a computer 206. The payment card interface module 204 is communicatively coupleable to the payment card 202. The advertisement comprises data corresponding to a message for calling a consumer's attention to a product. In this context, “communicatively coupleable” means that the payment card 202 can be temporarily communicatively coupled to the payment card interface module 204. The payment card interface module 204 may have a card reader that is able to communicate/interact with the payment card 202. In the case of a “contactless” payment card, communication is established when the payment card comes within range of the card reader. In the case of a payment card with an EMV chip, communication is established when the card is physically inserted (“dipped”) into the card reader so that it comes into contact with the EMV chip.

The computer 206 is communicatively coupled to the payment card interface module 204 and configured to retrieve (A) the advertisement that is stored on a database 208. More than one advertisement may be retrieved. The computer 206 may have suitable storage drives to implement the database 208. The database 208 may be implemented using a server and/or a cloud-computing storage module that are/is communicatively coupled to the computer 206. Alternatively, the database 208 may be part of the computer 206. A plurality of advertisements are stored on the database 208. Each advertisement may comprise at least one of: (i) a marketing message, i.e. data corresponding to a message for calling a consumer's attention to a product, (ii) a manufacturer or merchant who owns/is paying for the advertisement (i.e. an advertiser), (iii) a ranking of the advertisement, and (iv) a tag associated with the advertisement.

The computer 206 is also configured to transmit (B) the retrieved advertisement(s) to the payment card interface module 204 and apply at least one pre-defined rule to determine the retrieval (A) of the advertisement from the database 208 and/or transmittal (B) of the advertisement to the payment card interface module 204.

The payment card interface module 204 is configured to receive (B′) the advertisement from the computer 206 and thereafter transmit (C) the advertisement to the payment card 202 when the payment card interface module 204 is communicatively coupled to the payment card 202.

The payment card 202 comprises a display screen 203 that is configured to display the advertisement. Further details on the payment card 202 and display screen 203 will be provided below.

The payment card interface module 204 comprises a point-of-sale terminal 205 that is configured to receive (D) payment card identification data during authorization of a transaction. The payment card identification data is associated with the payment card 202 and is used for identifying a payment card holder. The payment card identification data includes at least one of an account number, a unique identifier and card holder identification data. The computer 206 is configured to receive (D′) the payment card identification data from the payment card interface module 204.

The computer 206 processes the payment card identification data to identify the payment card holder. Once the payment card holder is identified, the computer 206 obtains (E) historical behavioral data of the payment card holder which may be stored on the database 208 (or any other storage drive). Here, the pre-defined rule comprises retrieval of the advertisement based on the obtained historical behavioral data of the payment card holder. That is, the historical behavioral data of the payment card holder determines whether or not a particular advertisement is retrieved from the database 208. The historical behavioral data of the payment card holder may include, but it not limited to, historical spend behaviour that may be derived from transaction data corresponding to past transactions made using the payment card. Besides historical spend behaviour, it is possible to create a look-a-like database with customers having a similar profile and spend behavior. The information stored in this database can be used to determine whether or not a particular advertisement is retrieved from the database 208. Additionally or alternatively, the pre-defined rule may comprise transmittal of the advertisement to the payment card 202 based on the obtained historical behavioral data of the payment card holder. In such a case, the historical behavioral data of the payment card holder determines whether or not a particular advertisement is transmitted to the payment card 202. In either case, the advertisement is displayed on the payment card 202 in a targeted manner. This advantageously improves the reach/effectiveness of the advertisement.

The computer 206 may be further configured to assign a ranking to advertisements based on a price paid for displaying the advertisements on the display screen 203. In this instance, the pre-defined rule comprises retrieval of the advertisement based on its ranking. A manufacturer of the product or merchant selling the product usually pays for the advertisement to be displayed. For example, if the manufacturer or merchant pays more for its advertisement(s) to be displayed, its advertisement(s) can be assigned a higher rank. Advertisements with a higher rank are retrieved more frequently from the database than advertisements with a relatively lower rank. Consequently, advertisements with a higher rank are displayed on payment cards more frequently than advertisements with a relatively lower rank.

The computer 206 may also be further configured to assign a tag to the advertisement based on an advertiser's targeting strategy. In this instance, the pre-defined rule comprises retrieval of the advertisement based on the advertiser's targeting strategy. The advertiser's targeting strategy may be based on a characteristic of a potential consumer/customer of the manufacturer or merchant. Examples of such characteristics of the consumer include, but are not limited to: demographics (e.g. education, nationality, religion, ethnicity, income, age and gender) and location (city, state, country). More than one tag can be assigned to an advertisement. The tag may be a label or metadata that is used to locate (and retrieve) advertisements based on the advertiser's targeting strategy.

FIG. 3 shows a schematic of a payment card 300 for use in an electronic payment transaction according to an embodiment of the invention. The payment card 300 is similar to payment card 202 described above. The payment card 300 comprises a display screen 302 (similar to display screen 203 described above), a processing device 304 coupled to the display screen 302, and a communication module 306 that is coupled to the processing device 304. If necessary, the payment card 300 may further comprise an energy storage device 308 (i.e. power source) that is capable of providing operating power to the processing device 304, communication module 306 and/or the display screen 302. The energy storage device 308 may be a battery or a capacitive storage device.

In an embodiment, the processing device 304 may include a memory unit (not shown), or alternatively, may be coupled to memory unit. The term processing device or processor, as used herein, refers to central processing units, microprocessors, microcontrollers, reduced instruction set circuits (RISC), application specific integrated circuits (ASIC), logic circuits, and any other circuit or processor capable of executing the functions described herein.

The display screen 302 may comprise a liquid-crystal display (LCD) that is capable of displaying the advertisement, which is made up of alphabets, numerals, symbols, icons and graphics. The liquid-crystal display (LCD) may be a bi-stable or multi-stable display material that can maintain an image when power has been removed. In this way, energy storage device 308 may not be necessary. Alternatively, display screen 302 may comprise an electronic paper display (EPD). Alternatively, display screen 302 may be a light emitting diode (LED) display screen, an organic light emitting diode (OLED) display screen, or any other suitable type of display screen that is capable of displaying an advertisement.

In an exemplary embodiment, the processing device 304 provides display screen 302 with a signal, which is converted to a visual display by display screen 302. In some alternative embodiments, payment card 300 may include multiple display screens to facilitate displaying more advertisements than a single display screen 302.

The communication module 306 is configured to receive an advertisement from a computer (e.g. computer 206 described above) that is communicatively coupled thereto. The communication module 306 can be communicatively coupled to the computer via a point-of-sale terminal (e.g. point-of-sale terminal 205 described above). The point-of-sale terminal may have a card reader (or be connected to a card reader) that is able to communicate, using the communication module 306, with the payment card 300.

In the case of a “contactless” payment card, communication can be established when the payment card 300 (and communication module 306) comes within range of the card reader. In the case of a payment card 300 with an EMV chip, the EMV chip can be considered as the communication module 306 and communication is established when the card 300 is physically inserted (“dipped”) into the card reader so that it comes into contact with the EMV chip.

The above-mentioned computer is configured to: retrieve the advertisement that is stored on a database (e.g. database 208 described above), transmit the retrieved advertisement to the payment card 300 via communication module 306; and apply at least one pre-defined rule to determine the retrieval of the advertisement from the database and/or transmittal of the advertisement to the payment card 300 via the communication module 306.

Upon receiving the advertisement via the communication module 306, the processing device 304 is configured to output the advertisement to the display screen 302 for displaying the advertisement on the display screen 302. In particular, the processing device 304 is configured to provide display screen 302 with a signal, which is converted to a visual display by display screen 302. The display screen 302 may continuously display an advertisement until a new advertisement is to be displayed. Alternatively, the display screen 302 may be configured to display an advertisement for a certain period of time.

The processing device 304 may be configured to provide display screen 302 with the signal without any substantial delay. That is, after receiving one or more advertisements via the communication module 306, the processing device 304 is configured to provide display screen 302 with the signal without any substantial delay.

Alternatively, the processing device 304 may be configured to provide display screen 302 with the signal after a delay. That is, after receiving one or more advertisements via the communication module 306, the processing device 304, in conjunction with the above-mentioned memory unit, may be configured to store the advertisement(s) for a certain period of time. Once the period of time has elapsed or if trigger signal is received, the processing device 304 provides display screen 302 with the signal. A button that is disposed on the payment card 300 can be used by a card holder to activate the trigger signal. In this manner, the advertisement(s) can be displayed at the card holder's convenience. If there is more than one advertisement, the plurality of advertisements may be displayed sequentially.

In an embodiment, the payment card 300 includes a flexible body 310. Typically, flexible body 310 is sized according to a standard, for example, standards promulgated by the International Organization for Standardization (ISO) and the International Electrotechnical Commission (IEC). More specifically, ISO/IEC 7810:2003 ID-1 specifies a size for payment cards of 85.60 mm by 53.98 mm. Additionally, ISO/IEC 7813 specifies that an ID-1 compliant payment card have a thickness of 0.76 mm and corners rounded with a radius of 3.18 mm. Although the ISO/IEC defines a standard size for payment cards, it is to be understood that the methods and systems described herein may be performed with a payment card of any shape or size that allows payment card 300 to interact with point-of-sale terminal as described herein. In an exemplary embodiment, the display screen 302, processing device 304, communication module 306 and energy storage device 308 are at least partially sealed within the flexible body 310.

In an implementation, the communication module 306 may have a wireless or contactless communication interface, allowing remote or contactless communication between the payment card 300 and a point-of-sale terminal or other reader device. Payment cards having an ability to perform such contactless communication are provided with an antenna (not shown) for conducting contactless communication using, for example, radio frequency electromagnetic waves. An oscillator and additional circuitry for one or more of modulation, demodulation, down-conversion and the like may further be provided.

FIG. 4 depicts an exemplary computer/computing device 400, hereinafter interchangeably referred to as a computer system 400, where one or more such computing devices 400 may be used to facilitate execution of the above-described method for displaying an advertisement on a payment card. In addition, one or more components of the computer system 400 may be used to realize the computer 206. The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a storage drive 412, which may be a hard disk drive, a solid state drive or a hybrid drive and/or a removable storage drive 414, which may include a magnetic tape drive, an optical disk drive, a solid state storage drive (such as a USB flash drive, a flash memory device, a solid state drive or a memory card), or the like. The removable storage drive 414 reads from and/or writes to a removable storage medium 444 in a well-known manner. The removable storage medium 444 may include magnetic tape, optical disk, non-volatile memory storage medium, or the like, which is read by and written to by removable storage drive 414. As will be appreciated by persons skilled in the relevant art(s), the removable storage medium 444 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 440. Examples of a removable storage unit 422 and interface 440 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 422 and interfaces 440 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments of the inventions, the communication interface 424 permits data to be transferred between the computing device 400 and a data communication network, such as a public data or private data communication network. The communication interface 424 may be used to exchange data between different computing devices 400 which such computing devices 400 form part an interconnected computer network. Examples of a communication interface 424 can include a modem, a network interface (such as an Ethernet card), a communication port (such as a serial, parallel, printer, GPIB, IEEE 1393, RJ35, USB), an antenna with associated circuitry and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage medium 444, removable storage unit 422, a hard disk installed in storage drive 412, or a carrier wave carrying software over communication path 426 (wireless link or cable) to communication interface 424. Computer readable storage media refers to any non-transitory, non-volatile tangible storage medium that provides recorded instructions and/or data to the computing device 400 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the storage drive 412, or the interface 440. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

For example, in addition to displaying advertisements on payment cards, it is possible to display loyalty program messages/rewards on payment cards. Loyalty programs typically provide incentives to consumers or card holders to use their payment cards. Consumers or card holders can redeem these incentives (e.g. cash, reward point, airline miles, gift certificates, discount coupons, etc.) that accrue on the consumer's or card holder's account. For example, an issuer may issue a payment card to a card holder and offer a payment reward that is proportional to the amount of purchases the card holder places on the payment card. In addition to advertisements, the methods, systems and payment cards described above may be used to display loyalty program messages (e.g. the payment reward, a total number of loyalty points and/or a loyalty program balance) on the payment card. For example, in an embodiment of the invention, there is provided a method for displaying loyalty program messages on a payment card using a computer coupled to a database, the payment card comprising a display screen, the method comprising: retrieving, using the computer, loyalty program messages stored on the database; and transmitting the loyalty program messages from the computer to the payment card for displaying the loyalty program messages on the display screen, wherein at least one pre-defined rule is applied to determine the retrieval of the loyalty program messages from the database and/or transmittal of the loyalty program messages to the payment card.

1. A method for displaying an advertisement on a payment card using a computer coupled to a database, the payment card comprising a display screen, the method comprising:
retrieving, using the computer, an advertisement stored on the database; and
transmitting the advertisement from the computer to the payment card for displaying the advertisement on the display screen,
wherein at least one pre-defined rule is applied to determine the retrieval of the advertisement from the database and/or transmittal of the advertisement to the payment card.

2. The method as claimed in claim 1, further comprising:
receiving, at the computer, payment card identification data associated with the payment card for identifying a payment card holder; and
obtaining, using the computer, historical behavioral data of the payment card holder,
wherein the pre-defined rule comprises retrieval of the advertisement based on the obtained historical behavioral data of the payment card holder.

3. The method as claimed in claim 2, wherein the historical behavioral data of the payment card holder comprises historical spend behavior derived from transaction data corresponding to transactions made using the payment card.

4. The method as claimed in claim 1, further comprising:
assigning, using the computer, a ranking to the advertisement based on a price paid for displaying the advertisement on the display screen, wherein the pre-defined rule comprises retrieval of the advertisement based on its ranking.

5. The method as claimed in claim 1, further comprising:
assigning, using the computer, a tag to the advertisement based on an advertiser's targeting strategy, wherein the pre-defined rule comprises retrieval of the advertisement based on the advertiser's targeting strategy.

6. The method as claimed in claim 2, wherein the payment card identification data is received from a point-of-sale terminal during authorization of a transaction.

7. The method as claimed in claim 2, wherein the payment card identification data comprises at least one of an account number, a unique identifier and cardholder identification data.

8. The method as claimed in claim 1, wherein the advertisement comprises data corresponding to a message for calling a consumer's attention to a product.

9. The method as claimed in claim 1, further comprising the steps of:
retrieving, using the computer, a loyalty program message stored on the database; and
transmitting the loyalty program message from the computer to the payment card for displaying the loyalty program message on the display screen,
wherein the at least one pre-defined rule is applied to determine the retrieval of the loyalty program message from the database and/or transmittal of the loyalty program message to the payment card.

10. A network-based system for displaying an advertisement on a payment card, the system comprising:
a payment card interface module communicatively coupleable to the payment card; and
a computer communicatively coupled to the payment card interface module and configured to:
retrieve the advertisement that is stored on a database;
transmit the retrieved advertisement to the payment card interface module; and
apply at least one pre-defined rule to determine the retrieval of the advertisement from the database and/or transmittal of the advertisement to the payment card interface module,
wherein the payment card interface module is configured to:
receive the advertisement from the computer and transmit the advertisement to the payment card when communicatively coupled to the payment card,
wherein the payment card comprises a display screen that is configured to display the advertisement.

11. The system as claimed in claim 10, wherein the computer is further configured to:
receive payment card identification data associated with the payment card for identifying a payment card holder; and
obtain historical behavioral data of the payment card holder,
wherein the pre-defined rule comprises retrieval of the advertisement based on the obtained historical behavioral data of the payment card holder.

12. The system as claimed in claim 11, wherein the historical behavioral data of the payment card holder comprises historical spend behavior derived from transaction data corresponding to transactions using the payment card.

13. The system as claimed in claim 12, wherein the payment card interface module comprises a point-of-sale terminal that is configured to receive the payment card identification data during authorization of a transaction.

14. The system as claimed in claim 10, wherein the computer is further configured to:
assign a ranking to the advertisement based on a price paid for displaying the advertisement on the display screen, wherein the pre-defined rule comprises retrieval of the advertisement based on its ranking.

15. The system as claimed in claim 10, wherein the computer is further configured to:
assign a tag to the advertisement based on an advertiser's targeting strategy, wherein the pre-defined rule comprises retrieval of the advertisement based on the advertiser's targeting strategy.

16. The system as claimed in claim 11, wherein the payment card identification data comprises at least one of an account number, a unique identifier and cardholder identification data.

17. The system as claimed in claim 10, wherein the advertisement comprises data corresponding to a message for calling a consumer's attention to a product.

18. The system as claimed in claim 10, wherein the computer is further configured to:
retrieve a loyalty program message stored on the database;
transmit the retrieved loyalty program message to the payment card interface module; and
apply the at least one pre-defined rule to determine the retrieval of the loyalty program message from the database and/or transmittal of the loyalty program message to the payment card interface module.

19. A payment card for use in an electronic payment transaction, the payment card comprising:
a display screen;
a processing device coupled to the display screen; and
a communication module coupled to the processing device, the communication module configured to receive an advertisement from a computer communicatively coupled thereto, the computer configured to:
retrieve the advertisement that is stored on a database;
transmit the retrieved advertisement to the communication module; and
apply at least one pre-defined rule to determine the retrieval of the advertisement from the database and/or transmittal of the advertisement to the communication module,
wherein the processing device is configured to output the advertisement to the display screen for displaying the advertisement on the display screen.

20. The payment card as claimed in claim 19, wherein the communication module is communicatively coupled to the computer via a point-of-sale terminal.

21. The payment card as claimed in claim 19, wherein the display screen comprises a liquid-crystal display (LCD).

22. The payment card as claimed in claim 19, further comprising an energy storage device configured to provide operating power to the processing device, communication module and/or the display screen.
